(19) United States
(12) Patent Application Publication
(10) Pub. No.: US 2006/0064395 A1
(43) Pub. Date: Mar. 23, 2006

(54) Data element storage method

(76) Inventors: Christopher Andrew Seguin, Newark, DE (US); Douglas J. Skeffington, Wilmington, DE (US)

Correspondence Address: DADE BEHRING INC.;LEGAL DEPARTMENT, 1717 DEERFIELD ROAD, DEERFIELD, IL, 60015, US

(21) Appl. No.: 10/947,947

(22) Filed: Sep. 23, 2004

(51) Int. Cl. G06F 17/30

(52) U.S. Cl. 707/1

(57) ABSTRACT

Storing data from objects into a relational database to permit relative ease of interaction as between an SQL-responsive database and an object-based software program by using an attribute of the object to identify a location in a table in the database.

### FIELD OF THE INVENTION

This invention relates generally to object-oriented programming and to storage of data associated therewith into databases.

### BACKGROUND OF THE INVENTION

Object-oriented software (such as C#) is a well-known and widely used programming paradigm. Many software programs need to be able to persist data, either during program execution or subsequent to such execution. Object-oriented software is no exception to this general need. Relational databases are a well known and thoroughly vetted data storage vehicle and well serve this purpose in many applications. Unfortunately, for all its strengths, object-oriented software does riot typically map conveniently to the tables and rows that tend to characterize a relational database, because object-oriented software carries a generally smaller amount of data in contrast to the generally significantly larger data involves with relational databases.

This conundrum becomes more acute in a multi-person programming scenario. In such a setting different software programmers and designers are usually in control of different portions of the overall software design. For example, some portions of a program may be written by object-oriented software designers and other portions being written by database designers. In such a situation, considerable time, energy, and care may be required to ensure that the object-oriented portion is able to persist data and/or locate data through effective use of the database portion. Similar problems occur when new object-oriented software must interact effectively with one or more legacy databases.

One solution to storing and/or retrieving data from objects in the database is to seek to write structured query language (SQL) statements in each class that would allow the data to be stored and retrieved from the database. Unfortunately, this approach would tend to require that all software developers need to be proficient in SQL language. It also makes it difficult to optimize communications with the database. A more common solution is to consolidate all the SQL statements in a single object or set of objects. These objects are often dubbed the persistence layer. One issue with this approach is that each time an object or the database changes, one needs to make corresponding software changes.

Another potential solution to this problem is to store a mapping between the objects and the database tables in a separate file. Generation of SQL statements is relatively easy for a computer to accomplish, though relatively error prone for humans. Even when computer facilitated, however, the software developer will still typically need to edit multiple files when the objects or database changes.

One logical conclusion of this line of thought is to have the developers write the objects. A software tool can take the object and decide what the table should look like and generate a store and retrieve function. Indeed, a number of persistence layer software vendors propose such solutions. This, however, forces the system to make many requests of the database. Further, when working with data that are already in the database, the object designer is forced to create relatively unwieldy objects to use this mechanism.

A typical present solution correlates a given software programming object with a particular database table. That is, information (such as parameters) for one object is retained in a single corresponding table. Such an approach rests upon an uneasy mismatch of actual or perceived requirements. Different constraints typically apply to what constitutes a good design for object oriented programming on the one hand and a database on the other hand, and these two views on how to best implement a given portion of an overall program are often not well matched. Therefore, building out an optimized object program will often force a non-optimal database design. Conversely, building an object-oriented program to operate usefully with, for example, an optimized legacy database design can be difficult, tedious, and error prone.

### SUMMARY OF THE INVENTION

Pursuant to the present invention, data of various kinds and corresponding to different software programming objects can be readily stored in one or more data tables of a database and can be readily located and recalled to permit relative ease of interaction as between an SQL-responsive database on the one hand and an object-based software program on the other hand. The present invention can be readily and effectively employed with both new database designs and with legacy platforms. Similarly, these teachings can be employed by software designers without unduly altering the desired object-based architectural approach. As one potential result, the software designer can specify whatever objects are required to effect a given process and the database designers can essentially ignore much of the object-based nature of that effort.

### BRIEF DESCRIPTION OF THE DRAWINGS

The above needs are addressed through provision of the data element storage apparatus and method described in the following detailed description, particularly when studied in conjunction with the drawings, wherein:

FIG. 1 comprises a schematic view of a database as configured in accordance with various embodiments of the invention;

FIG. 1A comprises a schematic view of an exemplary database of FIG. 1;

FIG. 2 comprises a flow diagram as configured in accordance with various embodiments of the invention;

FIG. 3 comprises a flow diagram as configured in accordance with various embodiments of the invention;

FIG. 4 comprises a flow diagram as configured in accordance with various embodiments of the invention; and,

FIG. 5 comprises a flow diagram as configured in accordance with various embodiments of the invention.

FIG. 6 is a schematic plan view of an automated analyzer in which the present invention may be employed to advantage;

FIG. 7 is an enlarged schematic plan view of a portion of the analyzer of FIG. 6;

FIG. 7A is a perspective view of a reagent cartridge useful in the analyzer of FIG. 6; and,

FIG. 8 comprises a schematic view of a database as configured in accordance with an exemplary embodiment of the invention;

Various aspects of the invention will be apparent from the description and claims that follow.

### DETAILED DESCRIPTION OF THE PREFERRED EMBODIMENTS

A database according to the various embodiments of the invention generally includes at least one data table. The data table includes at least a first and second data element. The first data element can correspond to a first software programming object and, despite this relationship, the second data element can correspond to a second software programming object that is different from the first software programming object. In a preferred approach this database will include at least one of a relational database and a database that accepts SQL queries. As used herein, “SQL” refers to Structured Query Language and includes a standard interactive and programming language for getting information from and updating a database. SQL is both an ANSI and an ISO standard.

According to an exemplary embodiment of the invention, the data elements are retained in corresponding storage locations. These storage locations may include an associated data type indicator. For example, the indicator may include, without limitation, at least a portion of a name as is assigned to such storage locations, a variable that is associated with an attribute that corresponds to the information that corresponds to such data elements, or a postfix notation, to name a few. According to one approach, such storage locations may have a corresponding name and this name may include, at least in part, indicia of the data type.

For example, a software developer could define a class and place attributes on the fields and properties of a class. These attributes would include the name of the database table and the name of the column. When it is time for an instance of this class to be persisted, the software traverses the instance variables and properties to find these attributes. The software would then generate the appropriate SQL statement to persist the object into the database. Since an SQL insert or update command is a string, it can be helpful to provide a way to convert each value into a string. To facilitate this, part of the attribute can indicate the data type of the column. This could be done with a parameter on the attribute. A particular embodiment uses a two letter prefix to the column name. To retrieve the values, the software again traverses the object structure creating a select statement and a way to set the values back into the object. This approach will often also benefit from knowing the type of the data in the column as well.

Depending upon the embodiment, additional data tables can be included as appropriate. In a particular approach, such an additional data table may itself include, for example, a third data element that corresponds to the first software programming object notwithstanding that this third data element resides within a data table other than the first data table mentioned above.

So configured, corresponding inquiries, such as an SQL-compatible inquiry, may be used to identify a specific one of these data elements and to recall it from a corresponding data table. In particular, such a configuration can be used effectively when executing a software program comprised of a plurality of software programming objects. Such benefits can be obtained both when combining an object-oriented program with a legacy database and/or when designing a new object-oriented program in conjunction with one more supporting databases. In effect, this approach attempts to balance the two conflicting requirements noted above: to minimize the number of files that must be changed to store objects in the database while also minimizing the number of trips to the database needed to load a set of objects.

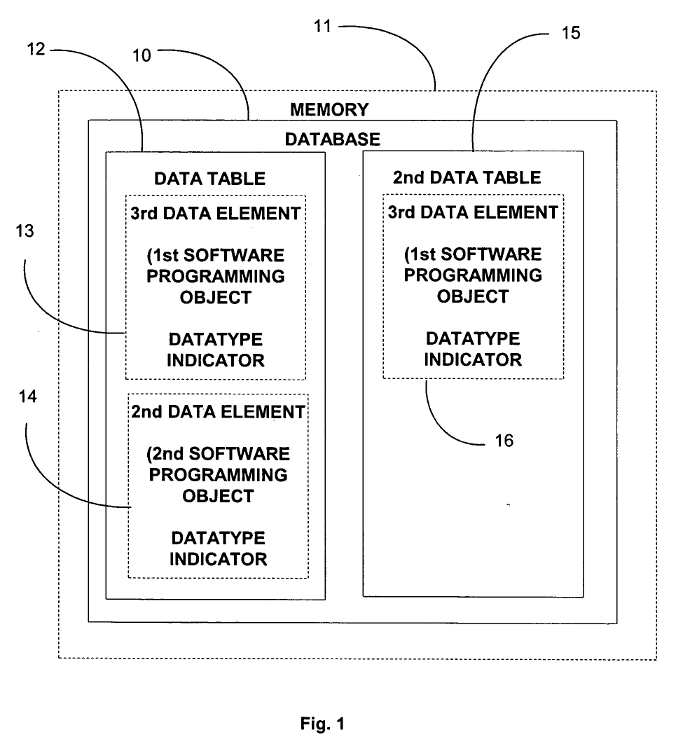

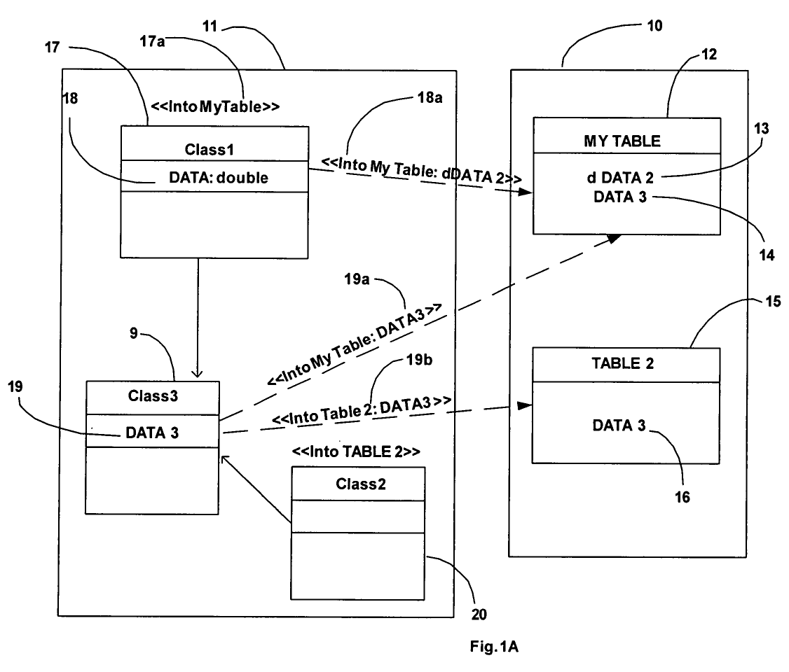

Referring now to the drawings, and in particular to FIG. 1, a database 10 is shown reposed within a corresponding memory environment 11. The database 10 may be, for example, a relational database and/or a database that accepts SQL queries. The memory 11 may include a central or remote platform and/or a self-contained or a distributed platform as is well understood in the art. The database 10 includes at least a first data table 12. This first data table 12 minimally includes at least a first data element and a second data element. Those skilled in the art will recognize that in practice, such a data table will typically include a large number of data elements. In the illustrative embodiment shown, the first data element corresponds to a first software programming object and the second data element similarly corresponds to a second software programming object, wherein the second software programming object is different from the first software programming object. According to one approach, this first data table 12 has a first storage location 13 that retains the first data element and a second storage location 14 that retains the second data element.

In one preferred approach, the information stored in at least some of such storage locations has an associated data type indicator. Virtually any type of data type can be retained and/or represented in this fashion, including but not limited to data types such as integers, doubles, time, dates, daytime indicia, and essentially any other primitive types as may be supported by the database structure itself. According to various approaches, such a data type indicator may include one or more of: at least a portion of a name as is assigned or is otherwise associated with the storage location as corresponds to the data itself; one or more variables as are associated with an attribute that corresponds to the data itself; or a postfix notation.

To illustrate, a given storage location can have a corresponding name. This name may itself include, at least in part, indicia of a data type that corresponds to the data type of the data element that this given storage location retains. For example, a predetermined portion of the name, such as a prefix, suffix, or otherwise bounded and identified parsed location (or locations when distributing the data type indicia over and amongst other name characters) can be used for this purpose. Such a naming convention can be static or dynamic as appropriate to the needs of a given application. For example, when static, predetermined and predefined storage locations can be pre-characterized as to the kinds of data elements that are properly storable therein. When dynamically assigned, storage locations can be dynamically characterized with respect to data type proximal to the time of storing a given data element in a given storage location. Regardless of whether such data types are fixed or alterable over time, however, it can be seen that such an approach will serve to provide a convenient mechanism for identifying certain characteristics of the data as stored at such a location.

As noted above, such a database 10 can include more than one such data table 12. To illustrate this point, FIG. 1 depicts an optional second data table 15. Those skilled in the art will recognize that a given database in a given application may well include considerably more data tables. Such an additional data table can retain a wide variety of data including but not limited to, for example, a third data element retained at a corresponding storage location 16. According to one embodiment, and for purposes of illustration, such a third data element can correspond, for example, to the same first software programming object as did the first data element that is retained in the first data table 12 at the first storage location 13.

Providing such flexibility permits considerable design and implementation freedom when configuring a given database and/or object-oriented software program with respect to one another. To illustrate, in the examples above, the first data element as retained in the first data table 13 can be substantially identical to the third data element as retained in the second data table 15. Of course, this does not constitute a requirement; these two data elements can be substantially dissimilar from one another notwithstanding that both correspond to the first software programming object. This does reflect favorably, however, upon the flexibility and accommodating nature of these conventions and configurations.

To further illustrate FIG. 1, a very simplified illustration may be seen in FIG. 1A in which object 17 needs to be stored in table 12 of relational database 10. Data element 18 is associated with object 17. Object 20 needs to be stored in table 15 of relational database 10. Another object 9 is shared by object 17 and object 20 and has associated data 19 that needs to go into Tables 12 and 15. Dashed arrows are used to indicate these needs for data storage in tables. String 17A indicates the association between object 17 and table 12. String 18A indicates the association between data 18 of object 17 and data 13 of table 12. String 19A indicates the association between data 19 of object 9 and data 14 of table 12. String 19B indicates the association between data 19 of object 9 and data 16 of table 15.

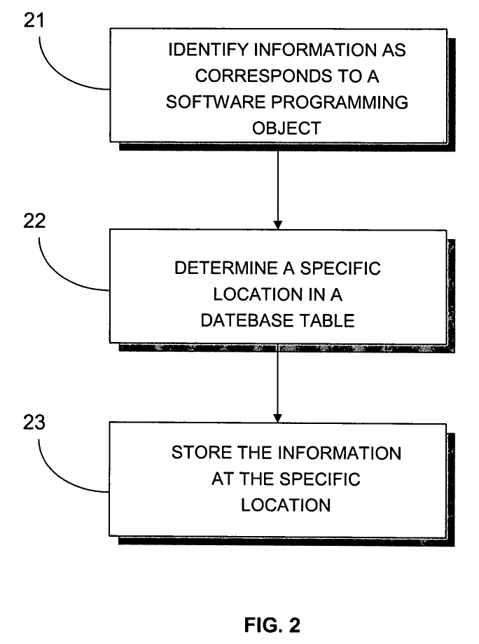

Referring now to FIG. 2, and presuming the availability of such a database 10, one can identify (shown at 21) information as corresponds to a software programming object. The software programming object may be, for example, one of a plurality of software programming objects as may used during execution of an object-oriented software program. A specific location in a given database table can then be determined (at 22) and the identified information then stored (at 23) at that specific location. Such storage can be facilitated, for example, by forming one or more SQL-compatible strings that include information as corresponds to the specific location. According to one approach, and as suggested above, a data type indicator can be used to characterize such information as stored at this particular storage location and that can be subsequently used during further execution of the object-oriented software program. Additional details regarding the storage of data elements as correspond to a particular software programming object are presented below.

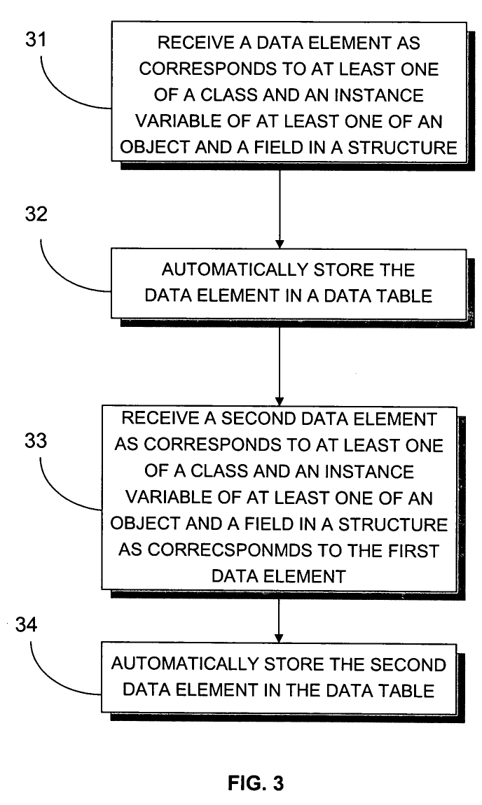

As an illustrative example, and referring now to FIG. 3, a process can receive (shown at 31) a data element that corresponds to at least one of a class and an instance variable of at least one of an object and a field in a structure. As used herein, “structure” refers to a collection of data without any specific implied behavior. “Class” refers to a combination of data and behavior and will typically be comprised of one or more fields and/or instance variables (i.e., data particular to a single instance of a corresponding class), class variables (i.e., data shared by all instances of a corresponding class), or methods (i.e., specified behavior or behaviors). An “object” refers to an instance of a class. Such a data element can then be automatically stored (at 32) in a data table of the database.

Upon receiving (at 33) a second data element, which second data element corresponds to at least one of a class and an instance variable of at least one of an object and a field in a structure as also corresponds to the first data element received above, this process can then effect automatic storage (at 34) of that second data element in the same data table.

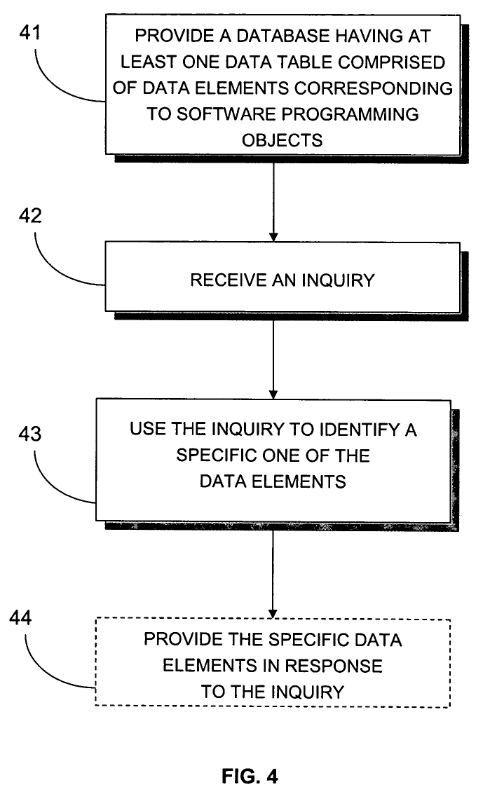

As another illustrative example, and referring now to FIG. 4, a database is provided (at 41) which may be a relational database, or at least a database that will respond to SQL compatible queries and storage instructions as suggested above. The database may have at least one data table. Those skilled in the art will recognize that a plurality of data tables are likely to be more appropriate for many applications. The one or more date tables each include a plurality of data elements that each correspond to any of a plurality of software programming objects. Depending upon the needs of the application, these software programming objects can all share a common class or, if desired, do not necessarily need to all share a common class.

Upon receiving (at 42) an inquiry, such as an SQL-compatible inquiry, from an authorized source in accord with well understood prior art practice, that inquiry can then be used (at 43) to identify at least a specific one of the plurality of data elements. In a preferred embodiment, that specific data element is then provided (at 44) in response to the inquiry.

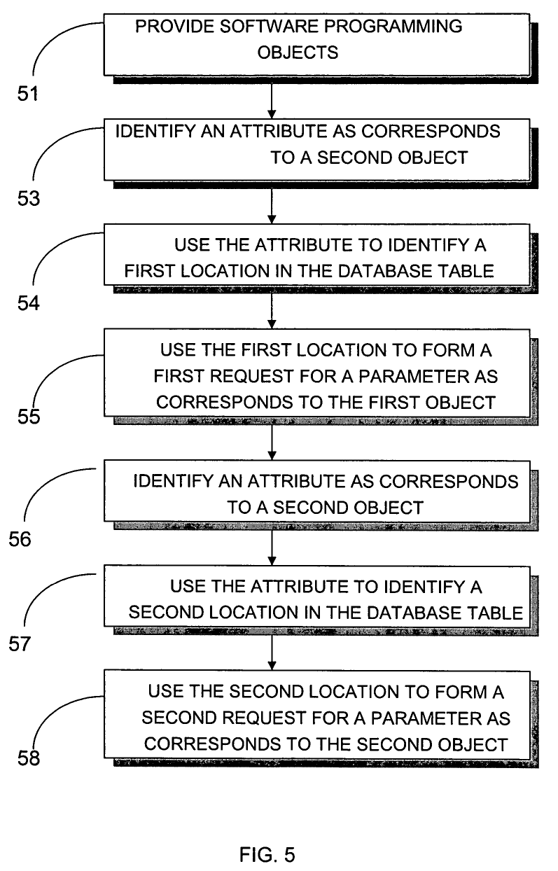

The above embodiments and examples provide a parsed view of various configurations and working attributes that may be employed according to the present invention. Referring now to FIG. 5, subsequent to provision (at 51) of a plurality of software programming objects and during execution of a software program that refers to and makes use of such software programming objects, the present invention can be generally employed to permit ease of interaction between such software programming objects and a database. According to one embodiment of the invention, the software programming objects that are compatible with a Microsoft® Intermediate Language (MSIL) such as, but not limited to, C#.

In particular, an attribute as corresponds to a first one of the software programming objects as is being used during execution of the program can be identified (at 53) and used (at 54) to identify a first location in a database table of the database. One example of an attribute is metadata that is associated with a class, a field, a method, and/or some property, which metadata is available at runtime through, for example, the use of reflection. According to one embodiment, the location naming conventions suggested above can be used in conjunction with software programming object metadata to facilitate such storage location identification. That first location information is then used (at 55) to form a corresponding request for a parameter as corresponds to this particular software programming object and that is stored at that first location. In particular, that location information can comprise a part of an SQL query that leads to recovery of the corresponding parameter information which recovered parameter information as corresponds to this software programming object can then be used during execution of the program.

In a similar fashion, an attribute (or attributes) as correspond to a second software programming object can be identified (at 56) and used (at 57) to identify a second location in that database table, such that this second location information is then used (at 58) to form another request for the parameter as is retained at that storage location and that corresponds to the second software programming object. It should be noted that such can be accommodated regardless of whether the first and second software programming objects share an identical class or not.

The following is an illustrative example. In a given application the software programming objects may pertain to any of three different classes denoted here as Class A, Class B, and Class C (where, for example, a given Object B would refer to an appropriate corresponding instance of Class B). For purposes of this illustration, these classes are characterized as follows:
Class A has a feature V (comprising, for example, a primitive value such as an integer);
Class B has a feature W (comprising, again, a primitive value) and a feature X (comprising, for example, an instance of Class A); and
Class C has a feature Y (again, a primitive value) and a feature Z (comprising, again, an instance of Class A).

The database in this illustrative example has a first data table for Class B parameters and a second data table for Class C parameters. The Class B data table has a first column for feature W and a second column for feature V while the Class C data table has a first column for feature Y and a second column, again, for feature V (as both feature X and feature Z of Class B and C, respectively, are an instance of Class A which is characterized by feature V).

Accordingly, entries for feature V for Class A are placed into both data tables for Class B and C. That is, a feature for one class is readily stored in tables that correspond to other classes.

Pursuant to these teachings, data of various kinds and as corresponds to different software programming objects can be readily stored in one or more data tables of a database and can be readily located and recalled to permit relative ease of interaction as between an SQL-responsive database on the one hand and an object-based software program on the other hand. These teachings can be readily and effectively employed with both new database designs and with legacy platforms. Similarly, these teachings can be employed by software designers without unduly altering the desired object-based architectural approach. As one potential result, the software designer can specify whatever objects are required to effect a given process and the database designers can essentially ignore much of the object-based nature of that effort.

For example, tags (as attributes in C# are referenced) in the object code can instruct a system regarding how to take the various properties of the various fields of a given object and store such information in the appropriate columns and storage locations of one or more data tables of a database. Similarly, one can create empty objects (i.e., objects lacking one or more parameters or other characterizing data) and then traverse such fields to identify the storage locations where the relevant data is retained. An SQL command can then be readily built in ordinary manner to retrieve such information and to then populate the corresponding data fields of the object with the retrieved information. Object attributes can serve to effect such marking. In general, nothing special needs be done to distinguish such attributes and identify them as being dedicated (or at least used) for such purposes when one uses reflection as is otherwise generally well understood in the art to focus only upon attributes of a specific type (i.e., an attribute of a type that specifies database accessing content).

The present invention may be advantageously employed in a number of instances in which data of various kinds and corresponding to different software programming objects is stored in one or more data tables of a database and may be readily located and recalled to permit relative ease of interaction as between an SQL-responsive database and an object-based software program. For example, in the automotive industry, the physical components of a fuel supply system per se may be described in an object-based software program while factors dealing with such a supply system; i.e., previous data concerning air-fuel mixture may be retained in an SQL-responsive database. In another example, in a solution mixing system, the physical components of the mixer per se may be described in an object-based software program while previous factors dealing with such a mixer; i.e., reaction characteristics of a material batch may be retained in an SQL-responsive database. In an exemplary embodiment of the present invention, consider a reagent cartridge for use within an automated clinical analyzer, the reagent cartridge having a number of different wells in which different reagents required to perform a clinical assay are stored, as explained below.

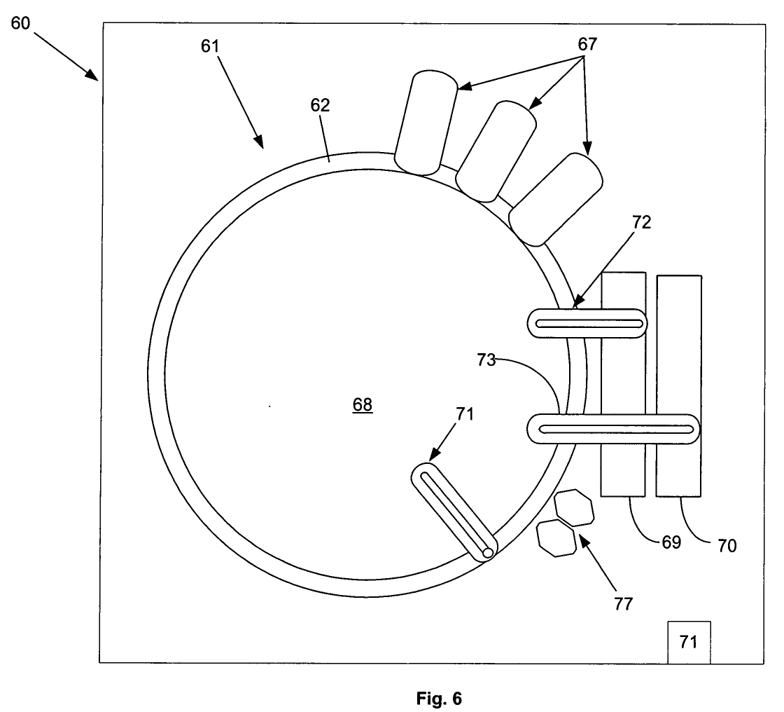

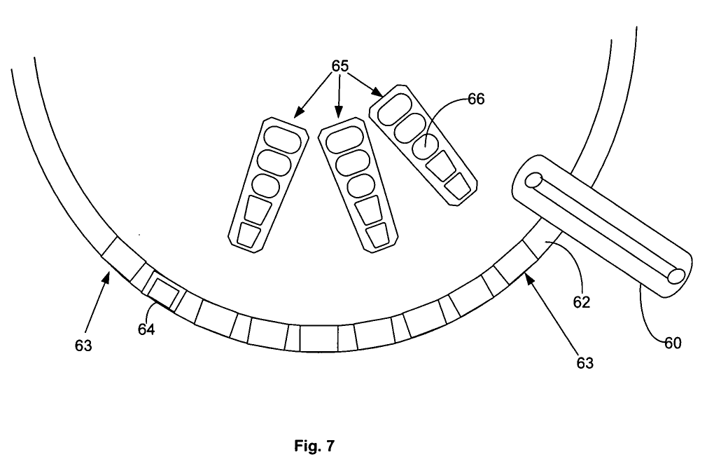

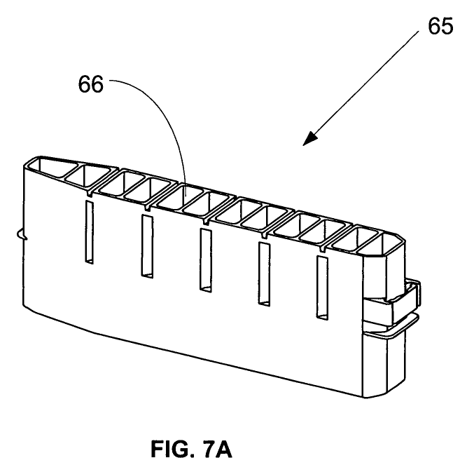

FIG. 6, taken with FIG. 7, shows a greatly simplified schematic of an automatic chemical analyzer 60 in which the present invention may be advantageously practiced, analyzer 60 comprising a reaction carousel 61 supporting a cuvette carousel 62 having cuvette ports 63 formed therein. Cuvette ports 63 are adapted to receive a plurality of reaction cuvettes 64 adapted to contain various reagents taken from a reagent cartridge 65 like that illustrated in FIG. 7A, reagent cartridge 65 containing reagents in wells 66 as necessary to perform a given assay. Sample liquids are dispensed into reaction cuvettes 63 so that analyzer 60 can perform various clinical and immunoassay assays. Reaction carousel 62 is rotatable using stepwise movements, the stepwise movements separated by a stationary dwell time during which assay operational devices 77, such as sensors, reagent add stations, mixing stations and the like, operate as needed on an assay mixture contained within a cuvette 64.

Analyzer 60 is controlled by software executed by the computer 71 based on computer programs written in a machine language like that used on the Dimension® clinical chemistry analyzer sold by Dade Behring Inc, of Deerfield, Ill., and widely used by those skilled in the art of computer-based electromechanical control programming. Computer 71 also executes application software programs for performing assays conducted by various analyzing means 67 within analyzer 60 and is further adapted to employ the present invention wherein data of various kinds and corresponding to different software programming objects can be readily stored in one or more data tables of a database and can be readily located and recalled to permit relative ease of interaction as between an SQL-responsive database on the one hand and an object-based software program on the other hand.

Temperature-controlled reagent storage areas 68, 69 and 70 store a plurality of multi-compartment elongate reagent cartridges 65 which may be moved for reagent preparation operations like hydration and remix, prior to access by reagent aspiration and dispense arms 71, 72 and 73. Reagent cartridges 65 may be loaded by an operator by placing such cartridges 65 into a cartridge loading tray 29 adapted to automatically translate cartridges 65 to a shuttling position described later.

The reagent aspiration and dispense arms 71, 72 and 73 comprise conventional liquid reagent probes are independently mounted and translatable between reagent storage areas 68, 69 and 70, respectively and cuvette carousel 61. Reagent aspiration and dispense arms 71, 72 and 73 aspirate reagents required to conduct specified assays from wells 66 in an appropriate reagent cartridge 65 and dispense reagent into reaction cuvettes 64 contained in cuvette ports 63 in cuvette carousel 62.

To one skilled in the art of automated clinical analyzers, it is known that a large number of parameters are associated with maintaining an inventory of reagent cartridges 65 as needed to perform a myriad of different assays. Such information as the identify of reagent cartridges 65 available on-board analyzer 60, how many assays can be performed with the reagent remaining in each reagent cartridge 65, how long has the reagent in reagent cartridge 65 been stored in analyzer 60, which server 68, 69 or 70 contains a particular reagent cartridge 65 and where within servers 68, 69, or 70 is a reagent cartridge 65 located, whether dilution is required and if so how much, and the like. Information such as those listed above plus additional data is best maintained in an SQL-responsive database. In contrast, the physical parameters associated with the reagent cartridge 65 per se is best described in an object-based software program.

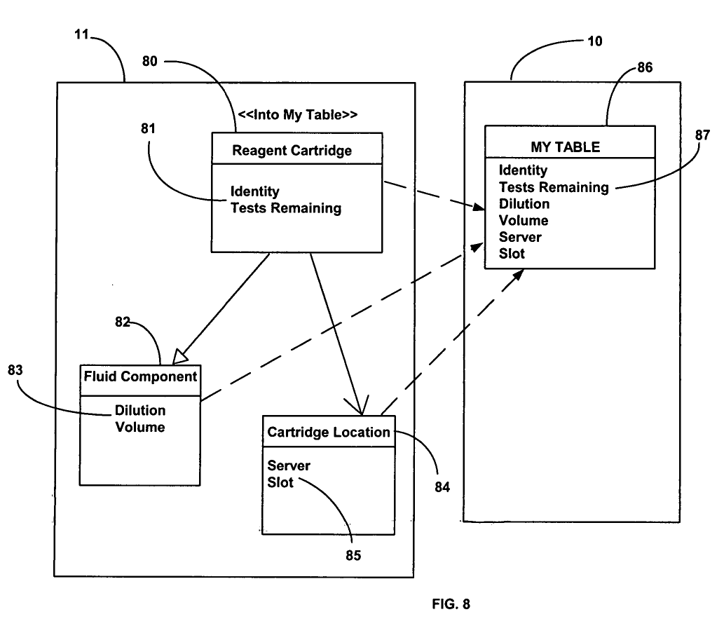

FIG. 8 is a simplified illustration of the present invention for the embodiment of reagent cartridge 65 and shows reagent cartridge 65 as being described in memory 11 having a first class 80 having data field 81 relating to the identify of and the number of assays that can be performed with reagent cartridge 65. A second class 82 might relate to the dilution characteristic data field 83 of each reagent cartridge 65 while a third class 84 might relate to a data field 85 identifying which server 68, 69 or 70 contains a particular reagent cartridge 65 and where within the server reagent cartridge 65 is located. The open triangle arrow between classes 80 and 82 means “inheritence” or “subclassing” while the arrow point between classes 80 and 84 means contains object. These are standard UML notations. All of the information in data fields 81, 83 and 85 need to be stored in a relational database and/or a database that accepts SQL queries in a single Reagent Cartridge database table 86 comprising data 87. In accord with the present invention as taught previously, each of the fields 81, 83 and 85 in classes 80, 82 and 84 would be tagged with an attribute so that data of various kinds and corresponding to different software programming objects can be readily stored in one or more data tables of a database and can be readily located and recalled by parsing the attributes of the properties of the classes 80, 82 and 84 to create the SQL commands 87, 88 and 89 to save and retrieve instances of reagent cartridge 65.

It should be readily understood by those persons skilled in the art that the present invention is susceptible of a broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention.

Accordingly, while the present invention has been described herein in detail in relation to specific embodiments, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

We claim:

1. A method to store data from objects into a database, the method comprising:
providing a plurality of software programming objects;
identifying at least one attribute as corresponds to a first one of the software programming objects;
using the at least one attribute to identify a first location in a table in a database;
using the first location to form a first request for a parameter as corresponds to the first one of the software programming objects;
identifying at least one attribute as corresponds to a second of the software programming objects;
using the at least one attribute as corresponds to the second of the software programming objects to identify a second location in the table in the database; and,
using the second location to form a second request for a parameter as corresponds to the second of the software programming objects.

2. The method of claim 1 wherein the first and the second software programming objects share an identical class.

3. The method of claim 1 wherein the first and the second software programming objects do not share an identical class.

4. The method of claim 1 wherein providing a plurality of software programming objects comprises providing a plurality of software programming objects that are compatible with a Microsoft® Intermediate Language (MSIL).

5. The method of claim 1 wherein using the first location to form a first request comprises forming an SQL-compatible request using the first location.

6. The method of claim 1 further comprising:
identifying information as corresponds to one of the software programming objects;
determining a specific location in the table of the database; and,
storing the information as corresponds to the one of the software programming object at the specific location in the table of the database.

7. The method of claim 6 wherein storing the information comprises forming at least one SQL-compatible string that includes information as corresponds to the specific location.

8. The method of claim 1 wherein providing a database having at least one data table comprises providing a database having at least two data tables, wherein at least one of the data tables comprises a plurality of data elements that correspond to a plurality of software programming objects.

9. The method of claim 8 wherein providing a database having at least two data tables comprises providing a database having at least two data tables, wherein at least two of the data tables each comprise a plurality of data elements that correspond to a plurality of software programming objects.

10. The method of 1 wherein the plurality of software programming objects all share a common class.

11. The method of claim 1 wherein the plurality of software programming objects includes at least some software programming objects that do not share a common class.

12. The method of claim 1 wherein the database comprises a relational database.
